(19) United States
(12) Patent Application Publication
(10) Pub. No.: US 2004/0204321 A1
(43) Pub. Date: Oct. 14, 2004

(54) Mgb2 based powder for the production of super conductOrs, method for the use and production thereof

(76) Inventors: Andreas Gumbel, Dresden (DE); Juergen Eckert, Darmstadt (DE); Ludwig Schultz, Dresden (DE); Birgit Bartusch, Dresden (DE)

Correspondence Address: JORDAN AND HAMBURG LLP, 122 EAST 42ND STREET, SUITE 4000, NEW YORK, NY, 10168, US

(21) Appl. No.: 10/471,526

(22) PCT Filed: Mar. 11, 2002
(86) PCT No.: PCT/DE02/00905

(30) Foreign Application Priority Data
Mar. 12, 2001 (DE) 101 12 457.0

(51) Int. Cl. H01B 1/00

(52) U.S. Cl. 505/100

(57) ABSTRACT

The invention relates to an MgB₂ based powder for the production of superconductors, having high reactivity which can be sintered at visibly lower temperatures and which can be compacted in large high density samples having a high superconductive transition temperature and a high critical current. The aim of the invention is achieved by virtue of the fact that the powder is a mechanical alloy powder, whose particles have an average size of d<250 μm and a substructure consisting of nanocrystalline grains whereby the dimensions thereof are <100 μm. The inventive powder can also contain additional chemical elements in the crystal grating of the MgB₂-power particles. In order to produce said inventive, a powder mixture comprising Mg-powder particles and B-powder particles powder is reduced by metal alloying optionally in the presence of additional chemical elements until an average particle size of <250 μm is achieved and a powder particle substructure comprising nanocrystalline grains measuring <100 μm is formed.

The invention relates to an MgB₂-based powder for the production of superconductors, and methods for the use and production thereof.

It is already known that the binary alloy MgB₂ is a superconductor at temperatures ranging from T_{c}=38° K to 40° K (J. Nagamatsu et al., Nature, volume 410 (2001), 63-64). For this purpose, a powder mixture, consisting of Mg powder and B powder, is first of all pressed cold. This molded object subsequently is processed further by hot isostatic pressing or sintering into solid bodies.

It is a disadvantage of this method that, for the hot isostatic pressing, high pressures are required in order to obtain dense samples and to prevent of the evaporation of Mg, which could result in a displacement of the stoichiometry and in disadvantageous supraconducting properties. Furthermore, during the sintering of conventional powders, there is a great increase in volume during the phase formation and cracks are therefore developed in the solid body. Moreover, during the sintering, the grain size is determined essentially by the heat treatment selected and only grains of the desired phase, the size of which is in the micrometer range and which have a low critical current, can be formed. The sintered samples generally are very brittle and have only a low density.

A superconducting MgB₂ wire has also already been prepared in that a boron wire was heat-treated at in the presence of magnesium powder in a quartz ampoule, magnesium diffusing into the boron wire (Canfield et al., Superconductivity in dense MgB₂ wires, Cond. Mat., to be published, cond-mat Homepage of 2-15-01; cond-mat/0102289). However, such a method is not suitable for producing industrial superconductors

It is therefore an object of the invention to create an MgB₂-based powder for producing superconductors, which has a high reactivity, so that, at clearly lower temperatures, it can be sintered and compacted to solid samples of high-density, a high superconducting transition temperature and a high critical current.

This objective is accomplished owing to the fact that the powder is a mechanically alloyed powder, the powder particles of which have an average particle size of less than 250 μm and a substructure consisting of nanocrystalline grains with dimensions of <100 nm.

Moreover, in accordance with an advantageous development of the invention, the chemical elements H, Li, Na, Be, Mg, B, Ca, Sr, Ba, Al, Ga, In, Tl, C, Si, Ge, Sn, Pb, N, O, P, As, Sb, Bi, F, Cl, La, Ce, Pr, Nd, Pm, Sm, Eu, Gd, Th, Dy, Ho, Er, Tm, Yb, Lu, Th, Ag, Cu, Au, Ni, Co, Pd, Pt, Sc, Y, Hf, Ti, Zr, Ta, V, Nb, Cr, Mo, Mn, Os and/or Ru are contained in the crystalline lattice of the powder particles.

For preparing an inventive powder, a powder mixture, consisting of magnesium powder particles and boron powder particles, is comminuted by means of mechanical alloying until an average particle size of <250 μm and the formation of a powder particle substructure, consisting of nanocrystalline grains, the dimensions of which are <100, are attained.

For preparing the above-mentioned MgB₂-powders, for which additional chemical elements are to be contained in the crystalline lattice, magnesium powder particles and boron powder particles are comminuted by mechanical alloying with the addition of up to 20 atom percent of powder particles of the chemical elements Li, Na, Be, Mg, Ca, Sr, Ba, Al, Ga, In, Ti, C, Si, Ge, Sn, Pb, As, Sb, Bi, La, Ce, Pr, Nd, Pm, Sm, Eu, Gd, Tb, Dy, Ho, Er, Tm, Yb, Lu, Th, Ag, Cu, Au, Ni, Co, Pd, Pt, Sc, Y, Hf, Ti, Zr, Ta, V, Nb, Cr, Mo, Mn, Os and/or Ru and/or powder particles of oxides, carbides, nitrides and/or their mixed crystals until an average particle size of <250 μm and the formation of a powder particle substructure, consisting of nanocrystalline grains less then 100 mm in size, are attained.

The mechanical alloying can be carried out under an inert gas or in air and/or in the presence of the gaseous elements H, N, O, and/or F.

After the mechanical alloying, the powder, if alloyed only partially, is subjected to a heat treatment.

For the heat treatment, a temperature is selected, which is at least 200° K below the typical reaction temperature of conventional powders of this type with powder particles, the size of which is in the micrometer range.

The powder is used in the completely or in the only partially alloyed version for producing high-temperature superconducting solid bodies, the powder being pressed into solid bodies, which are then sintered. In the event that an only partially alloyed powder is used, the temperature for the pressing is selected to be at least 200° K below the typical reaction temperature of conventional powders of this type with powder particles, the size of which is in the micrometer range.

Advantageously, the powder can also be used in the completely or only partially alloyed version as a starting powder for the powder-in-the-tube technology for producing high-temperature superconducting wires and ribbons. In the event that an only partially alloyed powder is used, the heat treatment, customary in the manufacturing process for forming the superconducting phase, is carried out at a temperature, which is at least 200° K below the typical reaction temperature of conventional powders of this type with powder particles, the size of which is in the micrometer range.

Within the scope of the inventive method, the heat treatment or the pressing advisably is carried out at temperatures between 300° C. and 900° C.

Included in the invention is the use of the inventive powder or of the solid bodies, produced therefrom, as a starting material or raw material for producing single crystals, wires and ribbons or as a target material for the deposition of layers.

The invention is distinguished by the following significant advantages.

Pursuant to the invention, the phase formation takes place either completely as a solid body reaction at low temperatures or due to the tempering of nanocrystalline secondary powder, which is significantly more reactive than commercially obtainable elementary and MgB₂ powders.

It is advantageous that, during the production of the inventive powder, there is no selective evaporation of individual components and that the stoichiometry as well as the proportion by volume of reacted phase with the AlB₂ structure can be adjusted precisely.

The inventive powder makes possible a unique nanocrystalline microstructure, which is comparable to that of layers.

The phase formation in partially reacted powder can take place due to additional tempering at temperatures clearly below the temperatures employed in the state of the art.

The powder and the superconducting solid bodies, which can be produced therefrom, have a better sample homogeneity and comparable superconducting transition temperatures of about 39° K.

The solid bodies, produced pursuant to the invention, can easily be produced and, in comparison to sintered samples, have a higher density of about 85% to 90% and are less brittle. They can also be ground, polished or sawn without problems.

The solid bodies, so produced, also have a better pinning behavior and a better current-carrying capability.

In comparison to conventionally sintered solid samples, a displacement of the irreversibility line Hᵢᵣᵣ to higher magnetic fields is achieved in an advantageous manner in the case of the inventively produced solid bodies, especially at low temperatures at a comparable H_{c2}. The strong displacement of Hᵢᵣᵣ to higher magnetic fields results in less separation between Hᵢᵣᵣ and H_{c2} and leads to stronger pinning behavior, which is significantly better than in the case of conventional solid samples and in the area of thin layers with c-axis texturing.

The inventive powder can also be used very well for powder-in-the-tube technology and makes good molding conditions possible in the case of extrusion molding and wire drawing.

The invention is described in greater detail below by means of examples.

### EXAMPLE 1

Conventional, commercial, crystalline magnesium powder and amorphous boron powder with particle sizes of a few μm are mixed in a ratio of 1:2 (atom percent) under the protection of argon gas in a tungsten carbide grinding beaker with a capacity of 20 mL and ground in a planetary ball mill. The grinding process takes place using 45 tungsten carbide grinding balls having a diameter of 10 mm, the ratio by weight of balls to powder is 36 and the speed of the planetary ball mill is 250 rpm. The grinding process is carried out for a period of 20 hours. At the end of the grinding process, a secondary powder is obtained, which consists of different nanocrystalline and amorphous phases.

By examining the structure by means of x-ray diffractometry, it became clear that the powder mixture has approximately the following composition:

1. nanocrystalline magnesium

2. nanocrystalline MgB₂

3. amorphous boron (unreacted starting powder); can be recognized, however, only as amorphous substratum

4. nanocrystalline tungsten carbide from grinding abrasion; the proportion by volume is of the order of 1%.

The proportion of magnesium by volume is almost three times that of MgB₂.

The powder obtained was subsequently heated in a calorimeter at a rate of 20° K/min to 1173° K and this temperature was maintained for 10 minutes. A strongly exothermic reaction could be noted, which was caused by the formation of the MgB₂ phase and was finished already at a temperature below 973° K. The complete conversion into the MgB₂ phase was confirmed by x-ray diffractometry after the heat treatment.

For preparing solid molded objects, the untreated, secondary powder is pressed at a pressure of 640 MPa and a temperature of 973° K or a pressure of 760 MPa and a temperature of 853° K. The temperature and pressure are maintained in each case for 10 minutes. During this procedure also, an almost phase-pure MgB₂ is obtained. The proportion of the MgB₂ in the phase is in excess of 96% by volume. In addition, about 3% by volume of MgO and about 1% by volume of tungsten carbide grinding abrasion are present.

The density attained is about 85% of the theoretical density of MgB₂. The grain size of the superconducting MgB₂ phase is of the order of 40 nm to 100 nm. The superconducting transition temperature is about 34.5° K to 37° K. At 20° K, the solid material has a critical current density of about 10⁵ A/cm² and 1 Tesla and the irreversibility line Hᵢᵣᵣ(T) is shifted in the direction of higher fields, that is, Hᵢᵣᵣ˜0.8 H_{c2}(T) in contrast to the value of Hᵢᵣᵣ˜0.5 Hᵢᵣᵣ(T), which is obtained conventionally for untextured, sintered solid samples.

### EXAMPLE 2

Conventional, commercial, crystalline magnesium powder and amorphous boron powder with particle sizes of a few μm are mixed in a ratio of 1:2 (atom percent) under the protection of argon gas in a tungsten carbide grinding beaker, having a capacity of 250 mL and ground in a planetary ball mill. The grinding process takes place using 45 tungsten carbide grinding balls having a diameter of 10 mm, the ratio by weight of balls to powder is 36 and the speed of the planetary mill is 250 rpm. The grinding process is carried for a period of 50 hours. At the end of the grinding process, a secondary powder is obtained, which consists of different nanocrystalline and amorphous phases.

By examining the structure by means of x-ray diffractometry, it became clear that the powder mixture has approximately the following composition:

1. nanocrystalline magnesium

2. nanocrystalline MgB₂

3. amorphous boron (unreacted starting powder); can be recognized, however, only as amorphous substratum

4. nanocrystalline tungsten carbide from grinding abrasion; the proportion by volume is of the order of 1%.

In comparison with shorter grinding times, the proportion of magnesium by volume is clearly lower and the proportion of MgB₂ clearly higher.

The powder obtained is subsequently heated in a calorimeter at a rate of 20° K/min to 1173° K and this temperature is maintained for 10 minutes. Here also, an exothermic reaction could be noted clearly. It was brought about by the formation of the MgB₂ phase and was finished already at a temperature below 873° K. However, since a higher proportion by volume of the MgB₂ phase is already present in the untreated secondary powder, the amount of energy released is significantly less than in the case of the secondary powder after a 20-hour grinding duration. The complete conversion into the MgB₂ phase was confirmed by x-ray diffractometry after the heat treatment.

For preparing solid molded objects, the untreated, secondary powder is pressed at a pressure of 640 MPa at a temperature of 973° K or a pressure of 760 MPa at a temperature of 853° K. The temperature and pressure are maintained in each case for 10 minutes. During this procedure also, an almost phase-pure MgB₂ is obtained. The proportion of the MgB₂ phase is in excess of 97% by volume. In addition, about 2% by volume of MgO and about 1% by volume of tungsten carbide grinding abrasion are present.

The density attained is about 90% ofthe theoretical density of MgB₂. The grain size of the superconducting MgB₂ phase is of the order of 40 nm to 100 nm. The superconducting transition temperature is about 30° K to 34.5° K. At 20° K, the solid material has a critical current density of about 10⁵ A/cm² and 1 Tesla and the irreversibility line is shifted, that is, Hᵢᵣᵣ˜0.8 H_{c2}(T) in contrast to Hᵢᵣᵣ˜0.5 Hᵢᵣᵣ(T), a value conventionally obtained for untextured, sintered solid samples.

### EXAMPLE 3

Conventional, commercial, crystalline magnesium powder and amorphous boron powder with particle sizes of a few μm are mixed in a ratio of 1:2 (atom percent) under the protection of argon gas in a tungsten carbide grinding beaker, having a capacity of 250 mL and ground in a planetary ball mill. The grinding process takes place using 45 tungsten carbide grinding balls having a diameter of 10 mm, the ratio by weight of balls to powder is 36 and the speed of the planetary mill is 250 rpm. The grinding process is carried for a period of 100 hours. At the end of the grinding process, a secondary powder is obtained, which consists of different nanocrystalline and amorphous phases.

By examining the structure by means of x-ray diffractometry, it became clear that the powder mixture has approximately the following composition:

1. nanocrystalline MgB₂

2. nanocrystalline tungsten carbide from grinding abrasion; the proportion by volume is of the order of 1%.

The proportion by volume of MgB₂ is approximately 98%. In addition, about 1% by volume of MgO and about 1% by volume of tungsten carbide are present.

The powder obtained was subsequently heated in a calorimeter at a rate of 20° K/min to 1173° K and this temperature is maintained for 10 minutes. In contrast to the secondary powders that had been ground for 20 hours and 50 hours, a clear reaction peak could not be identified here. The MgB₂ phase formation therefore took place completely already in the grinding beaker.

For preparing solid molded objects, the untreated, secondary powder is pressed at a pressure of 640 MPa at a temperature of 973° K. The temperature and pressure were maintained for 10 minutes. The density achieved is clearly less than in Examples 1 and 2 and amounts only to about 60% of the theoretical density of MgB₂. However, the sample also represents an almost pure phase. The grain size of the superconducting MgB₂ phase ranges from 40 nm to 100 nm. The superconducting transition temperature is about 30° to about 34.5° K. At 20° K, the solid material has a critical current density of about 10⁵ A/cm² and 1 Tesla and the irreversibility line is shifted, that is, Hᵢᵣᵣ˜0.8 H_{c2}(T) in contrast to Hᵢᵣᵣ˜0.5 Hᵢᵣᵣ(T), a value conventionally obtained for untextured, sintered solid samples.

### EXAMPLE 4

Conventional, commercial, crystalline magnesium powder, silicon powder and amorphous boron powder with particle sizes of a few μm are mixed under the protection of argon gas in a tungsten carbide grinding beaker, having a capacity of 250 mL, in a ratio of (Mg₁₀₀₋ₓSiₓ; 0<x<10) 1:2 (B) (atom percent) and ground in a planetary ball mill. The grinding process takes place using 45 tungsten carbide grinding balls having a diameter of 10 mm, the ratio by weight of balls to powder is 36 and the speed of the planetary mill is 250 rpm. The grinding process is carried for a period of 20 hours. At the end of the grinding process, a secondary powder is obtained, which consists of different nanocrystalline and amorphous phases.

By examining the structure by means of x-ray diffractometry, it became clear that the powder mixture has approximately the following composition:

1. nanocrystalline magnesium and silicon

2. traces of Mg (Si)

3. nanocrystalline Mg₁₀₀₋ₓSiₓB₂

4. amorphous boron (unreacted starting powder); can be recognized, however, only as amorphous substratum

5. nanocrystalline tungsten carbide from grinding abrasion; the proportion by volume is of the order of 1%.

The proportion by volume of Mg, Si and Mg(Si) is about three times as high as that of Mg₁₀₀₋ₓSiₓB₂.

The powder obtained is subsequently heated in a calorimeter at a rate of 20° K/min to 1173° K and this temperature is maintained for 10 minutes. A strongly exothermic reaction could be noted clearly. It was brought about by the formation of the Mg₁₀₀₋ₓSiₓB₂ phase and was finished already at a temperature below 973° K. The complete conversion into the Mg₁₀₀₋ₓSiₓB₂ phase was confirmed by x-ray diffractometry after the heat treatment.

For preparing solid molded objects, the untreated, secondary powder is pressed at a pressure of 640 MPa at a temperature of 973° K or a pressure of 760 MPa at a temperature of 853° K. The temperature and pressure are maintained in each case for 10 minutes. During this procedure also, an almost phase-pure Mg₁₀₀₋ₓSiₓB₂ is obtained. The proportion of the Mg₁₀₀₋ₓSiₓB₂ phase is in excess of 96% by volume. In addition, about 3% by volume of MgO and about 1% by volume of tungsten carbide grinding abrasion are present.

The density attained is about 85% of the theoretical density of Mg₁₀₀₋ₓSiₓB₂. The grain size of the superconducting MgB₂ phase is of the order of 40 nm to 100 nm. The superconducting transition temperature is about 34° K to 38° K. At 20° K, the solid material has a critical current density of about 10⁵ A/cm² and 1 Tesla and the irreversibility line is shifted in the direction of higher fields, that is, Hᵢᵣᵣ˜0.8 H_{c2}(T) in contrast to Hᵢᵣᵣ˜0.5 Hᵢᵣᵣ(T), a value conventionally obtained for untextured, sintered solid samples.

### EXAMPLE 5

Conventional, commercial, crystalline magnesium powder, crystalline Fe powder and amorphous boron powder with particle sizes of a few μm are mixed in a ratio of (Mg₁₀₀₋ₓFeₓ; 0<x<5) 1:2 (B) (atom percent) under the protection of argon gas in a tungsten carbide grinding beaker, having a capacity of 250 mL and ground in a planetary ball mill. The grinding process takes place using 45 tungsten carbide grinding balls having a diameter of 10 mm, the ratio by weight of balls to powder is 36 and the speed of the planetary mill is 250 rpm. The grinding process is carried for a period of 20 hours. At the end of the grinding process, a secondary powder is obtained, which consists of different nanocrystalline and amorphous phases.

By examining the structure by means of x-ray diffractometry, it became clear that the powder mixture has approximately the following composition:

1. nanocrystalline Mg Fe

2. traces of Mg (Fe)

3. nanocrystalline Mg₁₀₀₋ₓFeₓB₂

4. amorphous boron (unreacted starting powder); can be recognized, however, only as amorphous substratum

5. nanocrystalline tungsten carbide from grinding abrasion; the proportion by volume is of the order of 1%.

The proportion by volume of Mg, Fe and Mg(Fe) is about three times as high as that of Mg₁₀₀₋ₓFeₓB₂.

The powder obtained is subsequently heated in a calorimeter at a rate of 20° K/min to 1173° K and this temperature is maintained for 10 minutes. A strongly exothermic reaction could be noted clearly. It was brought about by the formation of the Mg₁₀₀₋ₓFeₓB₂ phase and was finished already at a temperature below 973° K. The complete conversion into the Mg₁₀₀₋ₓFeₓB₂ phase was confirmed by x-ray diffractometry after the heat treatment.

For preparing solid molded objects, the untreated, secondary powder is pressed at a pressure of 640 MPa at a temperature of 973° K or a pressure of 760 MPa at a temperature of 853° K. The temperature and pressure are maintained in each case for 10 minutes. During this procedure also, an almost phase-pure Mg₁₀₀₋ₓFeₓB₂ is obtained. The proportion of the Mg₁₀₀₋ₓFeₓB₂ phase is in excess of 96% by volume. In addition, about 3% by volume of MgO and about 0.3% by volume of tungsten carbide grinding abrasion are present.

The density attained is about 85% of the theoretical density of Mg₁₀₀₋ₓFeₓB₂. The grain size of the superconducting Mg₁₀₀₋ₓFeₓB₂ phase is of the order of 40 nm to 100 nm. The superconducting transition temperature is about 30° K to 35° K. At 20° K, the solid material has a critical current density of about 10⁵ A/cm² and 1 Tesla and the irreversibility line is shifted in the direction of higher fields, that is, Hᵢᵣᵣ˜0.8 H_{c2}(T) in contrast to Hᵢᵣᵣ˜0.5 Hᵢᵣᵣ(T), a value conventionally obtained for untextured, sintered solid samples.

### EXAMPLE 6

Conventional, commercial, crystalline magnesium powder, crystalline Cu powder and amorphous boron powder with particle sizes of a few μm are mixed in a ratio of (Mg_{100-c}Cuₓ; 0<x<2) 1:2 (B) (atom percent) under the protection of argon gas in a tungsten carbide grinding beaker, having a capacity of 250 mL and ground in a planetary ball mill. The grinding process takes place using 45 tungsten carbide grinding balls having a diameter of 10 mm, the ratio by weight of balls to powder is 36 and the speed of the planetary mill is 250 rpm. The grinding process is carried for a period of 20 hours. At the end of the grinding process, a secondary powder is obtained, which consists of different nanocrystalline and amorphous phases.

By examining the structure by means of x-ray diffractometry, it became clear that the powder mixture has approximately the following composition:

1. nanocrystalline Mg and Cu

2. traces of Mg (Cu)

3. nanocrystalline Mg₁₀₀₋ₓCuₓB₂

4. amorphous boron (unreacted starting powder); can be recognized, however, only as amorphous substratum

5. nanocrystalline tungsten carbide from grinding abrasion; the proportion by volume is of the order of 1%.

The proportion by volume of Mg, Cu and Mg(Cu) is about three times as high as that of Mg₁₀₀₋ₓCuₓB₂.

The powder obtained is subsequently heated in a calorimeter at a rate of 20° K/min to 1173° K and this temperature is maintained for 10 minutes. A strongly exothermic reaction could be noted clearly. It was brought about by the formation of the Mg₁₀₀₋ₓCuₓB₂ phase and was finished already at a temperature below 973° K.

The complete conversion into the Mg₁₀₀₋ₓCuₓB₂ phase was confirmed by x-ray diffractometry after the heat treatment.

For preparing solid molded objects, the untreated, secondary powder is pressed at a pressure of 640 MPa at a temperature of 973° K or a pressure of 760 MPa at a temperature of 853° K. The temperature and pressure are maintained in each case for 10 minutes. During this procedure also, an almost phase-pure Mg₁₀₀₋ₓCuₓB₂ is obtained. The proportion of the Mg₁₀₀₋ₓCuₓB₂ phase is in excess of 96% by volume. In addition, about 3% by volume of MgO and about 0.3% by volume of tungsten carbide grinding abrasion are present.

The density attained is about 85% of the theoretical density of Mg₁₀₀₋ₓCuₓB₂. The grain size of the superconducting MgB₂ phase is of the order of 40 nm to 100 nm. The superconducting transition temperature is about 30° K to 35° K. At 20° K, the solid material has a critical current density of about 10⁵ A/cm² and 1 Tesla and the irreversibility line is shifted in the direction of higher fields, that is, Hᵢᵣᵣ˜0.8 H_{c2}(T) in contrast to Hᵢᵣᵣ˜0.5 Hᵢᵣᵣ(T), a value conventionally obtained for untextured, sintered solid samples.

### EXAMPLE 7

Conventional, commercial, crystalline magnesium powder, crystalline Si powder, crystalline Fe powder and amorphous boron powder with particle sizes of a few μm are mixed in a ratio of (Mg_{100-x-y}SiₓFe_{y}B₂; 0<x<5; 0<y<5) 1:2 (B) (atom percent) under the protection of argon gas in a tungsten carbide grinding beaker, having a capacity of 250 mL and ground in a planetary ball mill. The grinding process takes place using 45 tungsten carbide grinding balls having a diameter of 10 mm, the ratio by weight of balls to powder is 36 and the speed of the planetary mill is 250 rpm. The grinding process is carried for a period of 20 hours. At the end of the grinding process, a secondary powder is obtained, which consists of different nanocrystalline and amorphous phases.

By examining the structure by means of x-ray diffractometry, it became clear that the powder mixture has approximately the following composition:

1. nanocrystalline Mg, Si and Fe

2. traces of Mg(SiFe)

3. nanocrystalline Mg_{100-x-y}SiₓFe_{y}B₂

4. amorphous boron (unreacted starting powder); can be recognized, however, only as amorphous substratum

5. nanocrystalline tungsten carbide from grinding abrasion; the proportion by volume is of the order of 1%.

The proportion by volume of Mg, Si, Fe and Mg(SiFe) is about three times as high as that of Mg_{100-x-y}SiₓFe_{y}B₂.

The powder obtained was subsequently heated in a calorimeter at a rate of 20° K/min to 1173° K and this temperature is maintained for 10 minutes. A strongly exothermic reaction could be noted clearly. It was brought about by the formation of the Mg_{100-x-y}SiₓFe_{y}B₂ phase and was finished already at a temperature below 973° K.

The complete conversion into the Mg_{100-x-y}SiₓFe_{y}B₂ phase was confirmed by x-ray diffractometry after the heat treatment.

For preparing solid molded objects, the untreated, secondary powder is pressed at a pressure of 640 MPa at a temperature of 973° K or a pressure of 760 MPa at a temperature of 853° K. The temperature and pressure are maintained in each case for 10 minutes. During this procedure also, an almost phase-pure Mg_{100-x-y}SiₓFe_{y}B₂ is obtained. The proportion of the Mg_{100-x-y}SiₓFe_{y}B₂ phase is in excess of 96% by volume. In addition, about 3% by volume of MgO and about 0.3% by volume of tungsten carbide grinding abrasion are present.

The density attained is about 85% of the theoretical density of Mg₁₀₀₋ₓCaₓB₂. The grain size ofthe superconducting MB₂phase is ofthe order of 40 nm to 100 nm. The superconducting transition temperature is about 30° K to 35° K. At 20° K, the solid material has a critical current density of about 10⁵ A/cm² and 1 Tesla and the irreversibility line is shifted in the direction of higher fields, that is, Hᵢᵣᵣ˜0.8 H_{c2}(T) in contrast to Hᵢᵣᵣ˜0.5 Hᵢᵣᵣ(T), a value conventionally obtained for untextured, sintered solid samples.

1. Powder, based on MgB₂, for the production of superconductors, wherein the powder is a mechanically alloyed powder, the powder particles of which have an average particle size of d<250 μm and a substructure including nanocrystalline grains having a dimensions of <100 nm.

2. The powder of claim 1, wherein the following chemical elements are contained in the crystalline lattice of the powder particles: H, Li, Na, Be, Mg, B, Ca, Sr, Ba, Al, Ga, In, Tl, C, Si, Ge, Sn, Pb, N, O, P, As, Sb, Bi, F, Cl, La, Ce, Pr, Nd, Pm, Sm, Eu, Gd, Tb, Dy, Ho, Er, Tm, Yb, Lu, Th, Ag, Cu, Au, Ni, Co, Pd, Pt, Sc, Y, Hf, Ti, Zr, Ta, V, Nb, Cr, Mo, Mn, Os and/or Ru.

3. The method for producing a powder, based on MgB₂, for the production of superconductors, wherein the powder is a mechanically alloyed powder and the powder particles have an average particle size of d<250 μm and a substructure including nanocrystalline grains having a dimension of <100 nm, whereby, according to the method, a powder mixture, comprising Mg powder particles and boron powder particles, is comminuted until an average particle size of d<250 μm is reached and a powder particle structure including nanocrystalline grains less than 100 nm in size is formed by mechanical alloying.

4. The method for producing a powder, based on MgB₂, for the production of superconductors wherein the powder is a mechanically alloyed powder and the powder particles have an average particle size of d<250 μm and a substructure including nanocrystalline grains having a dimensions of <100 nm, the following chemical elements being contained in the crystalline lattice of the powder particles: H, Li, Na, Be, Mg, B, Ca, Sr, Ba, Al, Ga, In, Tl, C, Si, Ge, Sn, Pb, N, O, P, As, Sb, Bi, F, Cl, La, Ce, Pr, Nd, Pm, Sm, Eu, Gd, Tb, Dy, Ho, Er, Tm, Yb, Lu, Th, Ag, Cu, Au, Ni, Co, Pd, Pt, Sc, Y, Hf, Ti, Zr, Ta, V, Nb, Cr, Mo, Mn, Os and/or Ru, whereby, according to the method, magnesium powder particles and boron powder particles and an addition of up to 20 atom percent of powder particles of the chemical elements Li, Na, Be, Mg, Ca, Sr, Ba, Al, Ga, In, Tl, C, Si, Ge, Sn, Pb, P, As, Sb, Bi, La, Ce, Pr, Nd, Pm, Sm, Eu, Gd, Tb, Dy, Ho, Er, Tm, Yb, Lu, Th, Ag, Cu, Au, Ni, Co, Pd, Pt, Sc, Y, Hf, Ti, Zr, Ta, V, Nb, Cr, Mo, Mn, Os and/or Ru and/or powder particles of oxides, carbides, nitrides and/or their mixed crystals are comminuted by mechanical alloying until an average particle size of d<250 μm is reached and a powder particle substructure including nanocrystalline grains less than 100 nm in size is formed.

5. The method of claim 4, wherein the mechanical alloying is carried out under a protective gas or in air and/or in the presence of the gaseous elements, H, N, O and/or F.

6. The method of claim 4, wherein after the mechanical alloying and in the event that the powder present is only partially alloyed, the powder is subjected to a heat treatment.

7. The method of claim 6, wherein a temperature is selected for the heat treatment which is at least 200° K below the typical reaction temperature of conventional powders of this type with powder particles, the size of which is in the micrometer range.

8. The method for using a powder, based on MgB₂, for the production of superconductors, wherein the powder is a mechanically alloyed powder and the powder particles have an average particle size of d<250 μm and a substructure including nanocrystalline grains having a dimension of <100 nm, whereby, according to the method, the powder is used in the completely or only partially alloyed version for the production of high-temperature superconducting solid bodies, the powder being pressed into solid bodies which are then sintered.

9. The method of claim 8, wherein in the event that an only partially alloyed powder is used, the temperature during the pressing is at least 200° K below the typical reaction temperature of conventional powders of this type with powder particles, the size of which is in the micrometer range.

10. The method for using a powder, based on MgB₂, for the production of superconductors, wherein the powder is a mechanically alloyed powder and the powder particles have an average particle size of d<250 μm and a substructure including nanocrystalline grains having a dimension of <100 nm, whereby, according to the method, the powder is used in the completely or only partially alloyed version as a starting powder for the powder-in-tube technology for producing high-temperature superconducting wires and ribbons.

11. The method of claim 8, wherein in the event that an only partially alloyed powder is used, the heat treatment, customary in the manufacturing process for forming the superconducting phase, is carried out at a temperature, which is at least 200° K below the typical reaction temperature of conventional powders of this type with powder particles, the size of which is in the micrometer range.

12. The method of claims 7, 9 or 11, wherein the heat treatment or the pressing is carried out at temperatures between 300° C. and 900° C.

13. The method for using a powder, based on MgB₂, for the production of superconductors, wherein the powder is a mechanically alloyed powder and the powder particles have an average particle size of d<250 μm and a substructure including nanocrystalline grains having a dimension of <100 nm, whereby, according to the method, the powder or the solid bodies, produced therefrom, are used as a starting material or a raw material for the production of single crystals, wires and ribbons or as a target material for the deposition of layers.

14. The method for using a powder, based on MgB₂, for the production of superconductors wherein the powder is a mechanically alloyed powder and the powder particles have an average particle size of d<250 μm and a substructure including nanocrystalline grains having a dimensions of <100 nm, the following chemical elements being contained in the crystalline lattice of the powder particles: H, Li, Na, Be, Mg, B, Ca, Sr, Ba, Al, Ga, In, Ti, C, Si, Ge, Sn, Pb, N, O, P, As, Sb, Bi, F, Cl, La, Ce, Pr, Nd, Pm, Sm, Eu, Gd, Tb, Dy, Ho, Er, Tm, Yb, Lu, Th, Ag, Cu, Au, Ni, Co, Pd, Pt, Sc, Y, Hf, Ti, Zr, Ta, V, Nb, Cr, Mo, Mn, Os and/or Ru, wherein, according to the method, the powder is used in the completely or only partially alloyed version as a starting powder for the powder-in-tube technology for producing high-temperature superconducting wires and ribbons.

15. The method for using a powder, based on MgB₂, for the production of superconductors wherein the powder is a mechanically alloyed powder and the powder particles have an average particle size of d<250 μm and a substructure including nanocrystalline grains having a dimensions of <100 nm, the following chemical elements being contained in the crystalline lattice of the powder particles: H, Li, Na, Be, Mg, B, Ca, Sr, Ba, Al, Ga, In, Tl, C, Si, Ge, Sn, Pb, N, O, P, As, Sb, Bi, F, Cl, La, Ce, Pr, Nd, Pm, Sm, Eu, Gd, Tb, Dy, Ho, Er, Tm, Yb, Lu, Th, Ag, Cu, Au, Ni, Co, Pd, Pt, Sc, Y, Hf, Ti, Zr, Ta, V, Nb, Cr, Mo, Mn, Os and/or Ru, wherein, according to the method, the powder or the solid bodies, produced therefrom, are used as a starting material or a raw material for the production of single crystals, wires and ribbons or as a target material for the deposition of layers.
